(19) United States
(12) Patent Application Publication
(10) Pub. No.: US 2024/0411940 A1
(43) Pub. Date: Dec. 12, 2024

(54) INSPECTION METHOD AND SYSTEM FOR THREE-DIMENSIONAL IMAGE GEOMETRIC DESIGN

(71) Applicants: Inventec (Pudong) Technology Corp., Shanghai (CN); Inventec Corporation, Taipei (TW)

(72) Inventor: Hsueh-Liang Chen, Taipei (TW)

(73) Assignees: Inventec (Pudong) Technology Corp., Shanghai (CN); Inventec Corporation, Taipei (TW)

(21) Appl. No.: 18/367,456

(22) Filed: Sep. 12, 2023

(30) Foreign Application Priority Data
Jun. 7, 2023 (CN) 202310673230.3

(51) Int. Cl. G06F 30/10; G06F 30/20; G06T 7/00; G06T 15/00; G06V 10/764; G06V 20/70

(52) U.S. Cl. CPC G06F 30/10; G06F 30/20; G06T 7/0006; G06T 15/00; G06V 10/764; G06V 20/70

(57) ABSTRACT

An inspection method for three-dimensional (3D) image geometric design includes capturing a three-dimensional image of an object; positioning a structural characteristic of the 3D image of the object; capturing a top view image of the positioned structural characteristic; and performing a geometric inspection for the top view image to determine whether the top view image corresponding to the object conforms to a geometric design condition or not.

### BACKGROUND OF THE INVENTION

### 1. Field of the Invention

The present invention relates to an inspection method and system for three-dimensional image geometric design, and more particularly, to an inspection method and system for three-dimensional image geometric design, capable of achieving intelligent geometric design inspection.

### 2. Description of the Prior Art

Massive structural design principles of internal elements are required for conventional electronic products during the design stage. After three-dimensional (3D) images of the internal elements of the electronic product are finished, checkpoints of the design of elements should be inspected. Since the conventional inspection procedure should be made manually, e.g. open, measure and compare the diagram files, which is time consuming and easily goes wrong.

Therefore, improvements are necessary to the conventional techniques.

### SUMMARY OF THE INVENTION

Therefore, the present invention provides an inspection method and system for three-dimensional image geometric design to achieve the intelligent geometric design inspection.

An embodiment of the present invention discloses an inspection method for three-dimensional (3D) image geometric design, comprises capturing a three-dimensional image of an object; positioning a structural characteristic of the 3D image of the object; capturing a top view image of the positioned structural characteristic; and performing a geometric inspection for the top view image to determine whether the top view image corresponding to the object conforms to a geometric design condition or not.

Another embodiment of the present invention discloses an inspection system for three-dimensional (3D) image geometric design, comprises a processing device; and a memory device, coupled to the processing device, configured to store a program code for instructing the processing device to execute an inspection method for 3D image geometric design, wherein the inspection method comprises: capturing a three-dimensional image of an object; positioning a structural characteristic of the 3D image of the object; capturing a top view image of the positioned structural characteristic; and performing a geometric inspection for the top view image to determine whether the top view image corresponding to the object conforms to a geometric design condition or not.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an inspection system for a three-dimensional (3D) image geometric design according to an embodiment of the present invention.

FIG. 2 is a schematic diagram of an inspection method according to an embodiment of the present invention.

FIG. 3 is a schematic diagram of an image recognition method according to an embodiment of the present invention.

FIG. 4 is a schematic diagram of a logic determination method according to an embodiment of the present invention.

FIG. 5 is a schematic diagram of an image recognition method according to an embodiment of the present invention.

FIG. 6 is a schematic diagram of a logic determination method according to an embodiment of the present invention.

FIG. 7 is a schematic diagram of an image recognition method according to an embodiment of the present invention.

FIG. 8 is a schematic diagram of a logic determination method according to an embodiment of the present invention.

FIG. 9 is a schematic diagram of an artificial intelligence (AI) recognition method according to an embodiment of the present invention.

FIG. 10 is a schematic diagram of generating different design diagram files according to a top view image of an object according to an embodiment of the present invention.

FIG. 11 is a schematic diagram of an annotated top view image according to an embodiment of the present invention.

FIG. 12 and FIG. 13 are schematic diagrams of automatic annotation and machine learning according to an embodiment of the present invention.

FIG. 14 and FIG. 15 are schematic diagrams of a dichotomy annotation training according to an embodiment of the present invention.

### DETAILED DESCRIPTION

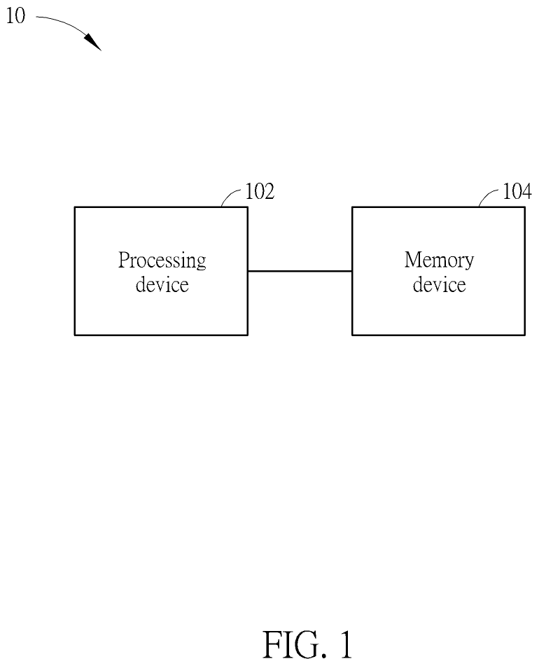

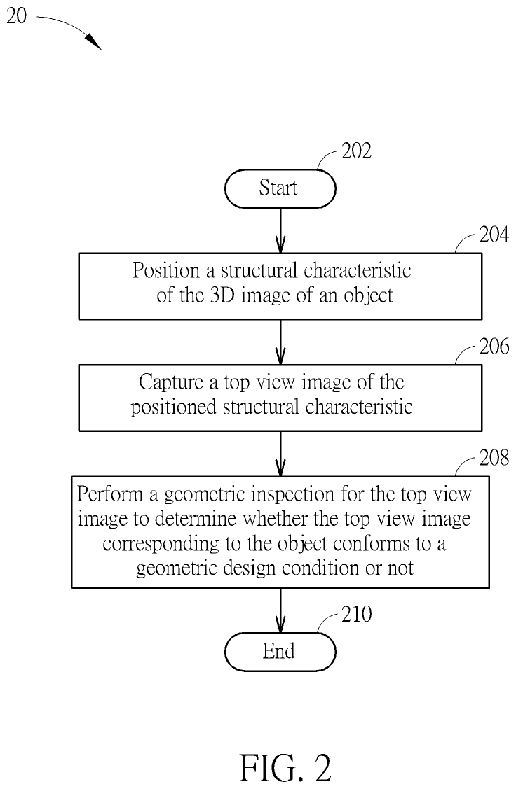

Please refer to FIG. 1, which is a schematic diagram of an inspection system 10 for a three-dimensional (3D) image geometric design according to an embodiment of the present invention. The inspection system 10 includes a processing device 102 and a memory device 104. The memory device 104 is coupled to the processing device 102, and is configured to store a program code for instructing the processing device 102 to execute an inspection method 20 for 3D image geometric design. The inspection method 20 may be utilized for inspecting elements of an electronic product, e.g. a hinge bracket, and the inspection method 20 includes the following steps:
Step 202: Start;
Step 204: Position a structural characteristic of the 3D image of an object;
Step 206: Capture a top view image of the positioned structural characteristic;
Step 208: Perform a geometric inspection for the top view image to determine whether the top view image corresponding to the object conforms to a geometric design condition or not;
Step 210: End.

The inspection system 10 may inspect whether the geometric design of the elements of the electronic product conforms to the geometric design condition or not according to the inspection method 20. For example, when an element of the electronic product is the hinge bracket, the geometric design condition at least includes: two positioning pillars, screws cannot be allocated on an identical horizontal axis (e.g. an X-axis), wherein the geometric design condition may be designed or determined by a designer or a manufacturer to avoid geometric designs, not conforming to the geometric design conditions, during the design process.

Therefore, based on the inspection method 20, the inspection system 10 according to an embodiment of the present invention may capture the 3D image of the hinge bracket, position the structural characteristic of the hinge bracket, and capture the top view image of the positioned structural characteristic. Then, the inspection system 10 may perform a geometric inspection for the top view image of the hinge bracket, e.g. a plurality of circular holes on the hinge bracket and corresponding coordinates, to determine whether the design of the hinge bracket conforms to the geometric design condition or not according to the top view image of the hinge bracket.

In an embodiment, the inspection system 10 may open corresponding diagram files of the elements via Creo toolkit tool, centralize the images of the elements in the file, open the top view image, capture and store a minimal rectangle containing the file.

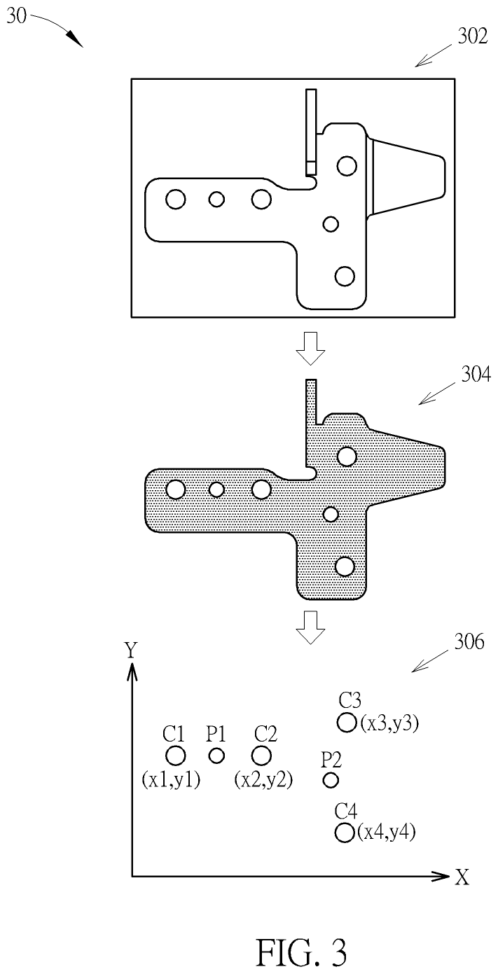

Furthermore, please refer to FIG. 3, which is a schematic diagram of an image recognition method 30 according to an embodiment of the present invention. In the embodiment of FIG. 3, the inspection system 10 may read the stored diagram files of the top view image via Phyton Open CV library (step 302), and perform a grayscale processing for the top view image to obtain a grayscale top view image, and perform a geometric characteristic image recognition for the top view image after the grayscale processing (step 304). In the above embodiment, color noises affecting the image recognition of the top view image after the grayscale processing may be removed to accelerate the processing of the image recognition.

Then, the inspection system 10 may re-illustrate at least a geometric characteristic corresponding to the top view image via HoughCircles function of Phyton Open CV library to examine the circular holes, i.e. re-illustrate the circles of the top view image in FIG. 3, and output radius of the circles and center coordinate of the circles (step 306).

In the example of FIG. 3, the top view image of the hinge bracket includes circles C1, C2, C3, C4 and positioning pillars P1, P2, wherein the circles C1, C2, C3, C4 are screw holes of the hinge bracket, coordinates (x1, y1), (x2, y2), (x3, y3), (x4, y4) are circle centers corresponding to the circles C1, C2, C3, C4 in an X-Y coordinate system. The inspection system 10 may classify the re-illustrated at least a geometric characteristic, i.e. classify the circular holes, and determine whether the top view image of the hinge bracket conforms to the geometric design condition or not according to a logic determination method corresponding to the geometric characteristic.

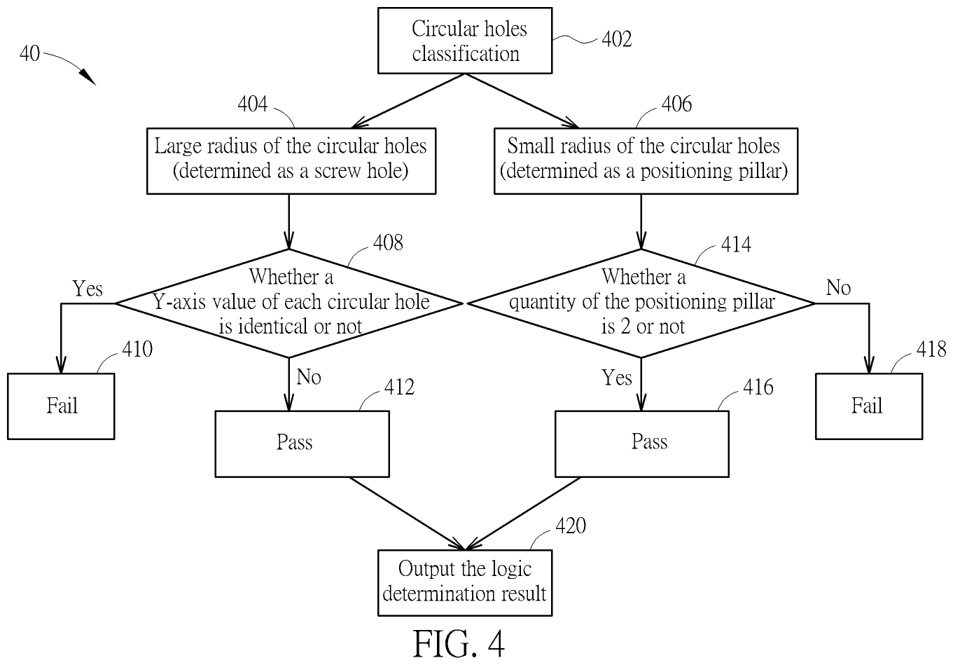

Please refer to FIG. 4, which is a schematic diagram of a logic determination method 40 according to an embodiment of the present invention. The logic determination method 40 is utilized for performing the logic determination for a classification of the circular holes. As shown in FIG. 4, a screw hole or a positioning pillar is determined according to a size of the circular hole instep 402. When a radius of the circular hole is large and determined as the screw hole (step 404), whether a Y-axis value of each circular hole is identical or not is determined in step 408. If the Y-axis value of each circular hole is identical, the logic determination is failed (step 410), i.e. a design structure of the hinge bracket is not stable; in contrast, if the Y-axis value of each circular hole is not identical, the logic determination is passed (step 412), i.e. the screw holes of the hinge bracket are not located on the same X-axis, which represents that the design structure is stable.

On the other hand, when the radius of the circular hole is small and determined as the positioning pillar (step 406), whether a quantity of the positioning pillar is 2 or not is determined in step 414. If the quantity of the positioning pillar is not equal to 2, the logic determination is failed, i.e. the positioning pillar is inadequate or overused; in contrast, if the quantity of the positioning pillar is equal to 2, the logic determination is passed. In step 420, the logic determination result of the geometric design of the hinge bracket is output.

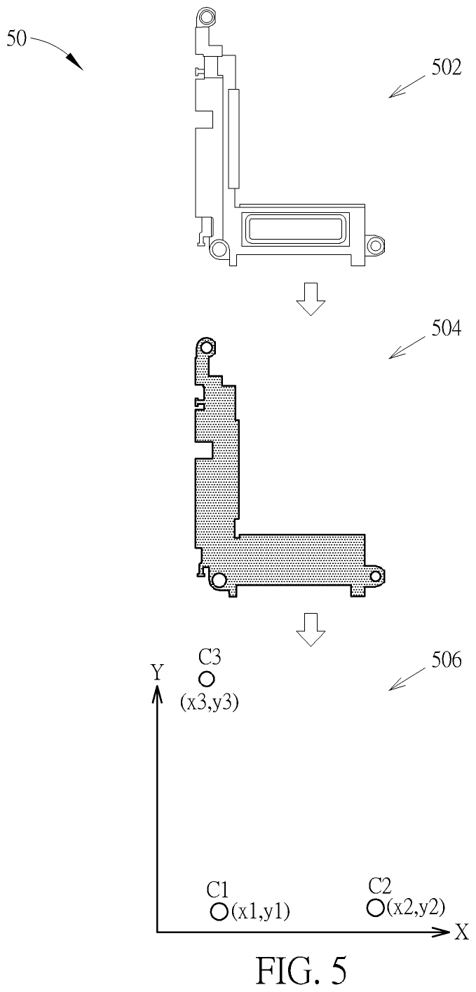

Please refer to FIG. 5, which is a schematic diagram of an image recognition method 50 according to an embodiment of the present invention. In the embodiment of FIG. 5, the inspection system 10 may read the stored diagram files of the top view image of the elements via Phyton Open CV library in step 502, and perform the grayscale processing for the top view image to obtain the top view image after the grayscale processing. Then, the inspection system 10 may perform the geometric characteristic image recognition for the top view image after the grayscale processing in step 504.

In the embodiment of FIG. 5, the top view image of the element includes circles C1, C2, C3 and positioning pillars P1, P2, wherein the circles C1, C2, C3 are screw holes of the hinge bracket. The coordinates (x1, y1), (x2, y2), (x3, y3) are circle centers corresponding to the circles C1, C2, C3 in the X-Y coordinate system. The inspection system 10 may classify the re-illustrated at least a geometric characteristic, i.e. classify the circular holes, and determine whether the top view image of the hinge bracket conforms to the geometric design condition or not according to a logic determination method corresponding to the geometric characteristic.

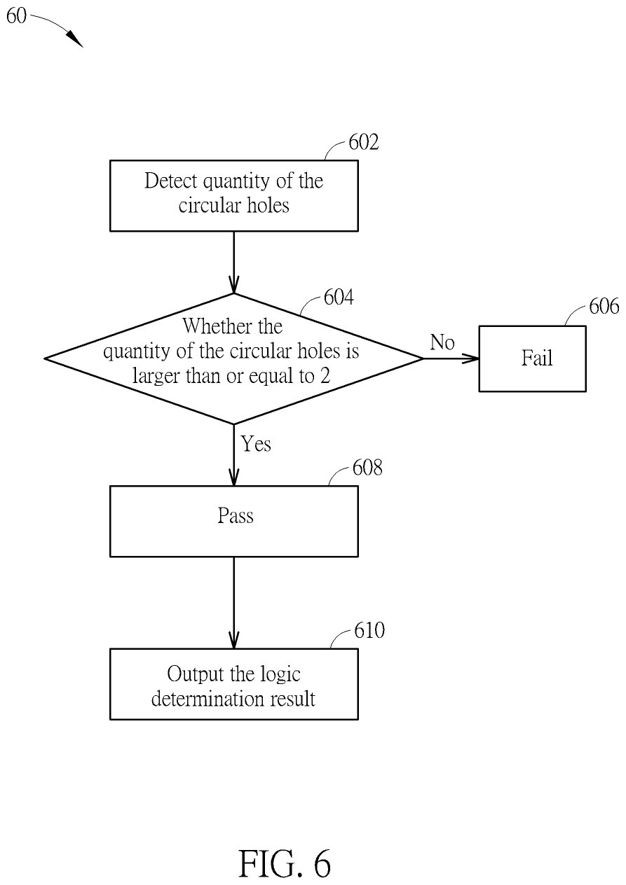

Please refer to FIG. 6, which is a schematic diagram of a logic determination method 60 according to an embodiment of the present invention. The logic determination method 60 is utilized for determining the logic determination of a quantity of the circular holes of the element. As shown in FIG. 6, the quantity of the circular holes is detected (in step 602) to determine whether the quantity of the circular holes is larger than or equal to 2 in step 604. If the quantity of the circular holes is less than 2, the logic determination of the design structure of the element is failed (step 606); in contrast, if the quantity of the circular holes is larger than or equal to 2 (in step 608), the logic determination is passed, i.e. the design structure is stable.

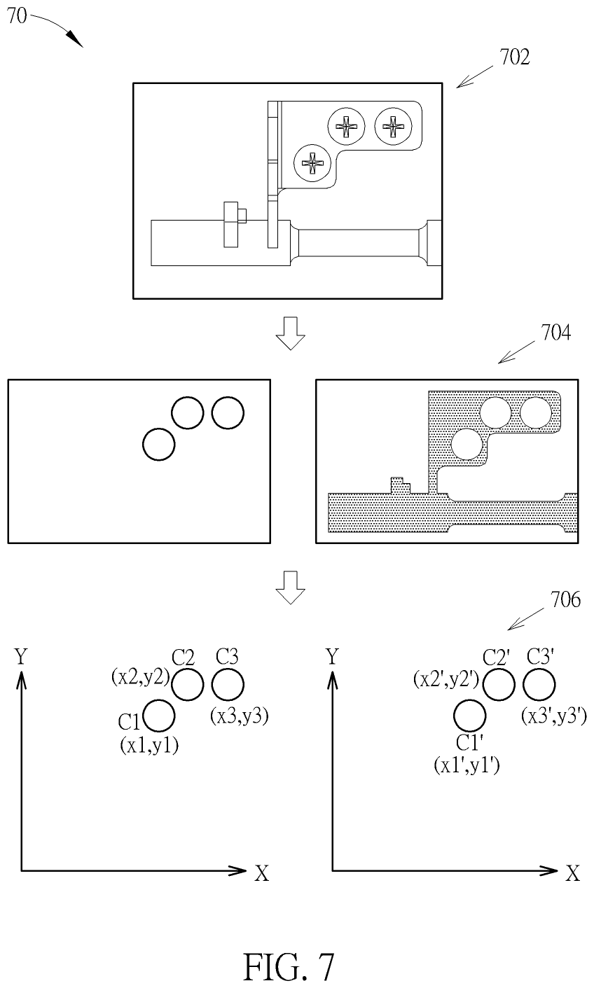

Please refer to FIG. 7, which is a schematic diagram of an image recognition method 70 according to an embodiment of the present invention. In the example of FIG. 7, the inspection system 10 may read the stored diagram files of the top view image of the element via Phyton Open CV library in step 702, and perform the grayscale processing for the top view image to obtain the top view image after the grayscale processing. Then, the inspection system 10 may perform the geometric characteristic image recognition for the top view image after the grayscale processing in step 704.

In FIG. 7, the inspection system 10 may compare three screw holes at a time. Alternatively, the inspection system 10 may compare one screw hole at a time and capture the image, wherein the screw is taken as a positioning center. As shown in FIG. 7, the circle recognition is performed and coordinates of the circle centers of the diagram files are output in step 704, and then the circles and the coordinates of the circle center of two diagram files are labeled in step 706, i.e. the circles C1, C2, C3 and corresponding coordinates of the circle centers (x1, y1), (x2, y2), (x3, y3), the circles C1′, C2′, C3′ and corresponding coordinates of the circle centers (x1′, y1′), (x2′, y2′), (x3′, y3′). And then, the logic determination of whether the top view image of the element conforms to the geometric design condition or not is determined.

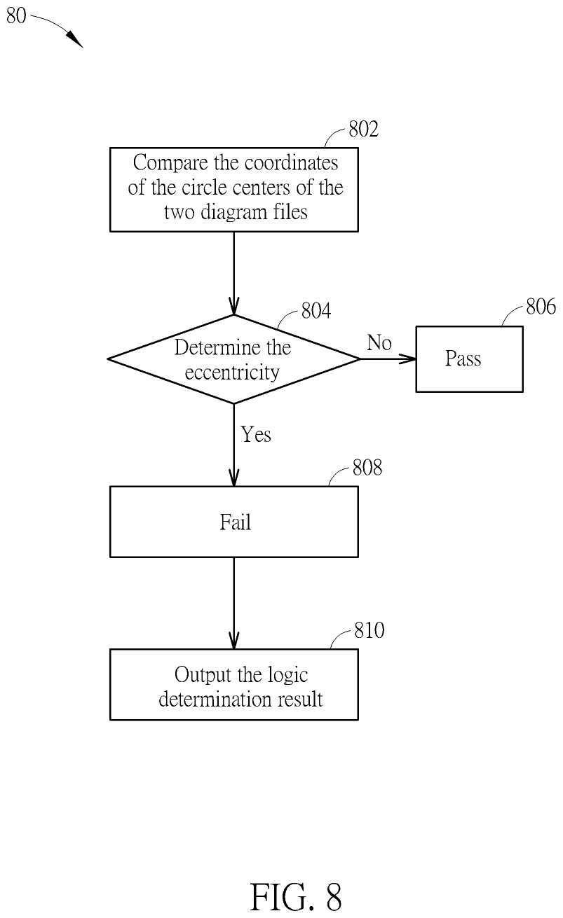

Please refer to FIG. 8, which is a schematic diagram of a logic determination method 80 according to an embodiment of the present invention. The logic determination method 80 is utilized for determining the eccentricity of the element. As shown in FIG. 8, the coordinates of the circle centers of the two diagram files of step 706 are compared (in step 802) to determine the eccentricity (step 804). If the circle centers of the two diagram files are not aligned, the logic determination corresponding to the design structure of the element is failed (step 806); in contrast, if the circle centers of the two diagram files are aligned (step 808), the logic determination is passed, i.e. the design structure is stable.

Different to the above embodiments, which perform the image recognition for geometric design of the top view image, the inspection system 10 may generate a plurality of diagram files corresponding to the top view image, according to the top view image of the element, and respectively perform an image annotation for the plurality of design diagram files, wherein the plurality of design diagram files are generated according to a relation instruction of a computer aided design (CAD) program, e.g. Creo relation instruction, and the image annotation of the plurality of design diagram files is implemented by a parametric method, e.g. Flexible modeling search and Syntax toolkit of Creo. Therefore, the inspection system 10 according to an embodiment of the present invention may implement the inspection method for the geometric design with automatic annotation of the design diagram and by applying the characteristics of geometric structure required by artificial intelligence (AI) training. That is, the inspection system 10 may perform a machine learning training for the design diagram files with the image annotation by applying a machine learning method to determine whether the top view image corresponding to the object conforms to the geometric design condition or not.

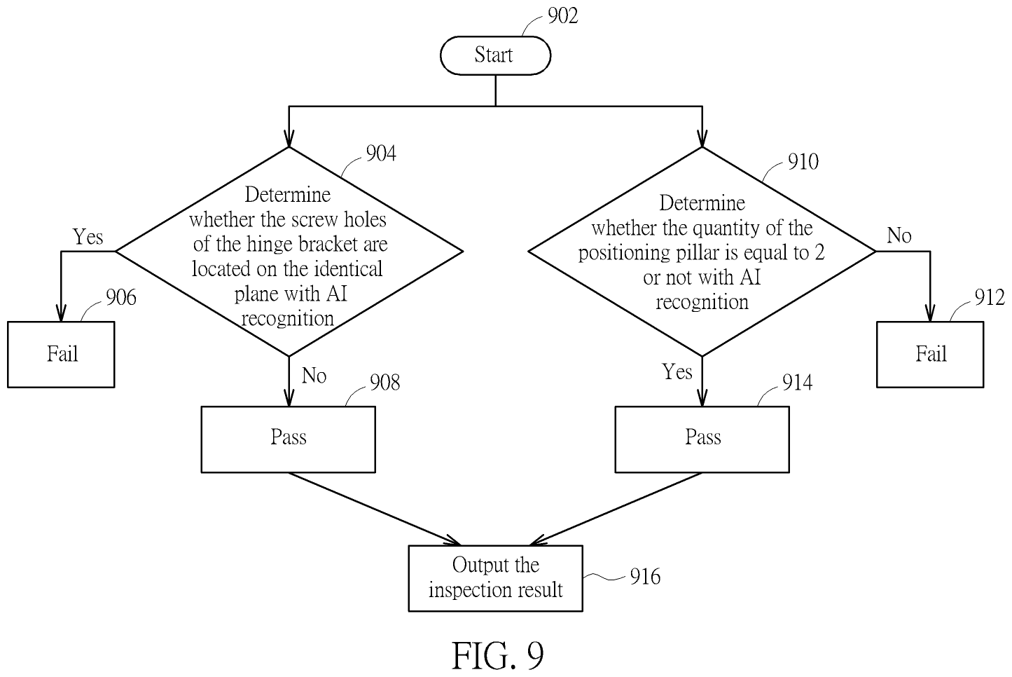

For example, please refer to FIG. 9, which is a schematic diagram of an AI recognition method 90 according to an embodiment of the present invention. The AI recognition method 90 maybe utilized for inspecting the geometric design of the hinge bracket and include the following steps:
Step 902: Start;
Step 904: Determine whether the screw holes of the hinge bracket are located on the identical plane with AI recognition, if yes, goes to Step 906; if no, goes to Step 908;
Step 906: The geometric inspection is failed;
Step 908: The geometric inspection is passed;
Step 910: Determine whether the quantity of the positioning pillar is equal to 2 or not with AI recognition, if yes, goes to Step 914; if no, goes to Step 912;
Step 912: The geometric inspection is failed;
Step 914: The geometric inspection is passed;
Step 916: Output the inspection result.

Notably, the inspection system 10 is configured to execute the AI recognition method 90 according to an AI training database to determine whether the element, e.g. the hinge bracket, conforms to the geometric design conditions or not.

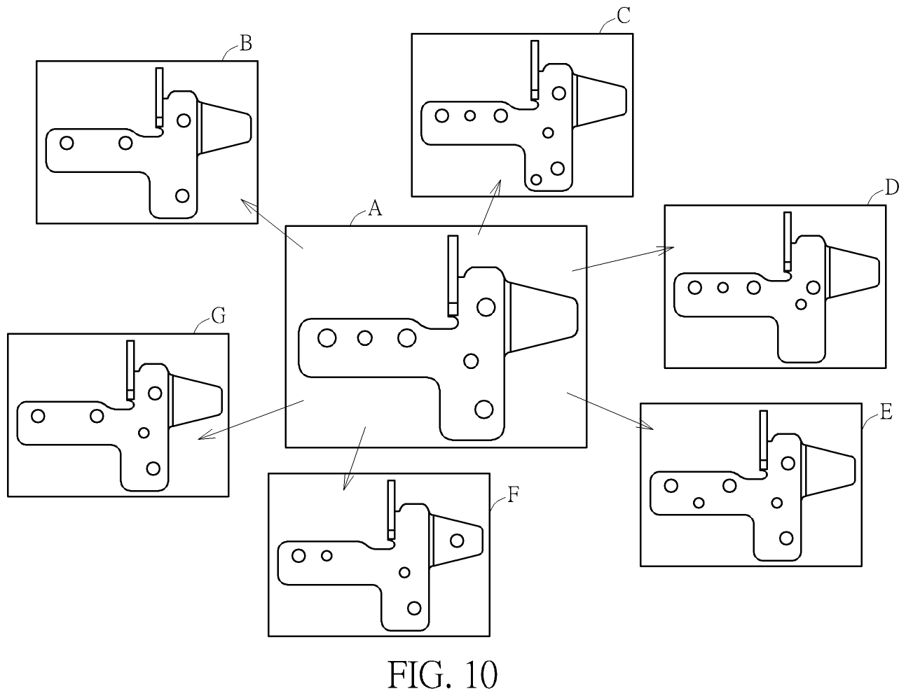

Please refer to FIG. 10, which is a schematic diagram of generating different design diagram files according to the top view image of the object according to an embodiment of the present invention. As shown in FIG. 10, the inspection system 10 may generate design diagram files B-G according to the design diagram file A of the top view image via the relation instruction of Creo, wherein the design diagram files B-G are different to the design diagram file A. The design diagram files B-G are elements related to the design diagram file A of the top view image.

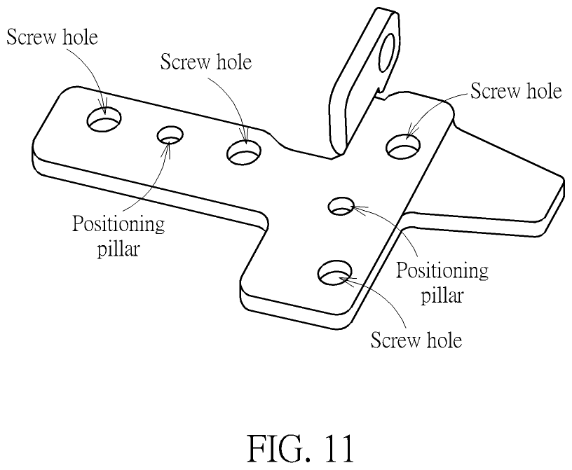

In addition, please refer to FIG. 11, which is a schematic diagram of an annotated top view image according to an embodiment of the present invention. As shown in FIG. 11, the inspection system 10 may automatically annotate required characteristics of circular holes according to the AI training database, e.g. Flexible modeling search and syntax toolkit of Creo, i.e. the annotation of screw holes and the positioning pillars in FIG. 11.

Based on FIG. 10 and FIG. 11, the inspection system 10 according to an embodiment of the present invention may establish the AI training database according to the machine learning method, e.g. Convolutional Neural Networks (CNN), the quantity of the positioning pillar, screw holes and the determination of whether the screw holes are located horizontally in different diagram files or not.

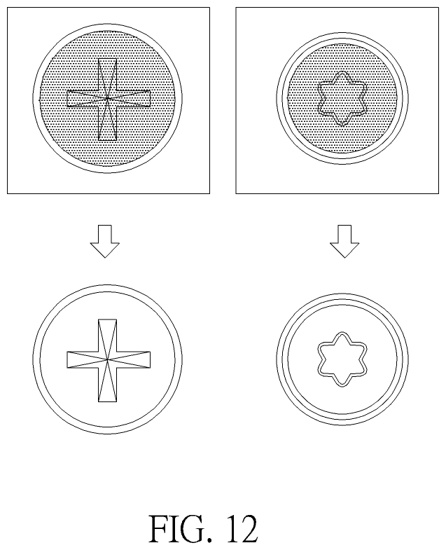

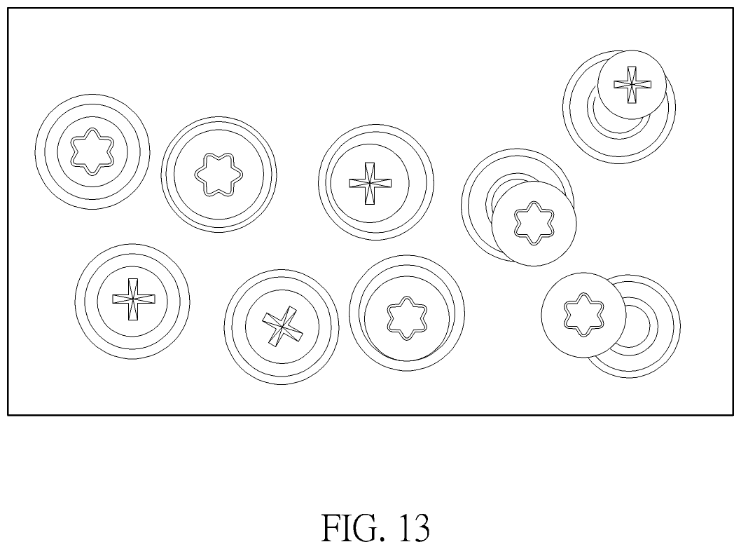

Please refer to FIG. 12 and FIG. 13, which are schematic diagrams of automatic annotation and machine learning according to an embodiment of the present invention. In the example of FIG. 12, the inspection system 10 may perform the grayscale processing for different types of screw holes and generate a large amount of design diagram files with size and corresponding condition s for AI training according to Flexible modeling search and syntax toolkit of Creo.

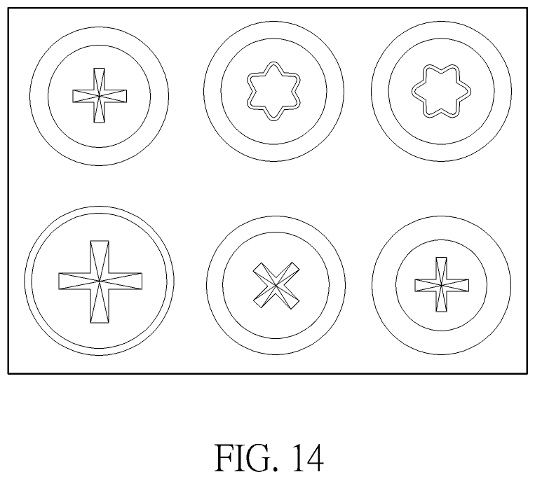

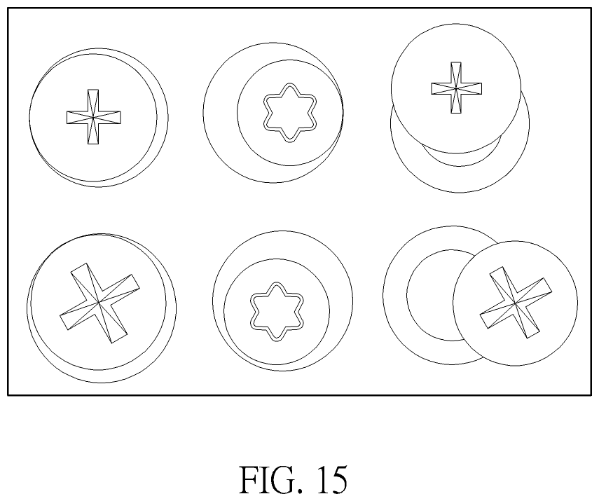

Then, the inspection system 10 may perform a dichotomy annotation training for the design diagram files in FIG. 13 according to the machine learning method, such that the design diagram files in FIG. 13 may be classified as a non-eccentric class (e.g. as shown in FIG. 14) and an eccentric class (e.g. as shown in FIG. 15). Therefore, the inspection system 10 may apply the above AI training database and the AI recognition method 90 for performing the geometric structural inspection for the captured top view image of the screw holes to determine the eccentricity.

Notably, those skilled in the art may make proper modifications to the display system according to different requirements. For example, the geometric design conditions, tools for loading the 3D image files, machine learning methods and modeling methods are not limited thereto and can be modified according to different user's preferences or system settings, which are all within the scope of the present invention.

In summary, the present invention provides an inspection method and system for three-dimensional image geometric design, which achieves an intelligent geometric design inspection via a combination of image recognition and logic determination automatic annotation, and a combination of automatic annotation and machine learning method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inspection method for three-dimensional (3D) image geometric design, comprising:
capturing a three-dimensional image of an object;
positioning a structural characteristic of the 3D image of the object;
capturing a top view image of the positioned structural characteristic; and
performing a geometric inspection for the top view image to determine whether the top view image corresponding to the object conforms to a geometric design condition or not.

2. The inspection method for three-dimensional image geometric design of claim 1, wherein the step of capturing the top view image of the positioned structural characteristic includes:
performing a grayscale processing for the top view image to obtain a grayscale top view image; and
performing a geometric characteristic image recognition for the geometric characteristic image.

3. The inspection method for three-dimensional image geometric design of claim 2, wherein the step of performing the geometric inspection for the top view image to determine whether the top view image corresponding to the object conforms to the geometric design principle or not includes:
re-illustrating at least a geometric characteristic corresponding to the top view image, according to a geometric characteristic image recognition result of the grayscale top view image;
classifying the re-illustrated at least a geometric characteristic; and
determining whether the top view image corresponding to the object conforms to the geometric design condition or not according to a logic determination method corresponding to at least a geometric characteristic.

4. The inspection method for three-dimensional image geometric design of claim 1, wherein the step of performing the geometric inspection for the top view image to determine whether the top view image corresponding to the object conforms to the geometric design condition or not includes:
generating a plurality of design diagram files corresponding to the top view image according to the top view image; and
respectively performing an image annotation for the plurality of design diagram files;
wherein the plurality of design diagram files are generated according to a relation instruction of a computer aided design (CAD) program;
wherein the image annotation of the plurality of design diagram files is implemented by a parametric method.

5. The inspection method for three-dimensional image geometric design of claim 4, wherein the step of performing the geometric inspection for the top view image to determine whether the top view image corresponding to the object conforms to the geometric design condition or not includes:
applying a machine learning method on the plurality of design diagram files with the image annotation to perform a machine learning training; and
determining whether the top view image of the object conforms to the geometric design condition or not according to the machine learning method.

6. An inspection system for three-dimensional (3D) image geometric design, comprising:
a processing device; and
a memory device, coupled to the processing device, configured to store a program code for instructing the processing device to execute an inspection method for 3D image geometric design, wherein the inspection method comprises:
capturing a three-dimensional image of an object;
positioning a structural characteristic of the 3D image of the object;
capturing a top view image of the positioned structural characteristic; and
performing a geometric inspection for the top view image to determine whether the top view image corresponding to the object conforms to a geometric design condition or not.

7. The inspection system for three-dimensional image geometric design of claim 6, wherein the step of capturing the top view image of the positioned structural characteristic includes:
performing a grayscale processing for the top view image to obtain a grayscale top view image; and
performing a geometric characteristic image recognition for the geometric characteristic image.

8. The inspection system for three-dimensional image geometric design of claim 7, wherein the step of performing the geometric inspection for the top view image to determine whether the top view image corresponding to the object conforms to the geometric design principle or not includes:
re-illustrating at least a geometric characteristic corresponding to the top view image, according to a geometric characteristic image recognition result of the grayscale top view image;
classifying the re-illustrated at least a geometric characteristic; and
determining whether the top view image of the object conforms to the geometric design condition or not according to a logic determination method corresponding to at least a geometric characteristic.

9. The inspection system for three-dimensional image geometric design of claim 6, wherein the step of performing the geometric inspection for the top view image to determine whether the top view image corresponding to the object conforms to the geometric design principle or not includes:
generating a plurality of design diagram files corresponding to the top view image according to the top view image; and
respectively performing an image annotation for the plurality of design diagram files;
wherein the plurality of design diagram files are generated according to an relation instruction of a computer aided design (CAD) program;
wherein the image annotation of the plurality of design diagram files is implemented by a parametric method.

10. The inspection system for three-dimensional image geometric design of claim 9, wherein the step of performing the geometric inspection for the top view image to determine whether the top view image corresponding to the object conforms to the geometric design principle or not includes:
applying a machine learning method on the plurality of design diagram files with the image annotation to perform a machine learning training; and
determining whether the top view image of the object conforms to the geometric design condition or not according to the machine learning method.
